(19) United States
(12) Patent Application Publication
(10) Pub. No.: US 2011/0160987 A1
(43) Pub. Date: Jun. 30, 2011

(54) METHOD AND APPARATUS FOR PROCESSING TRAFFIC INFORMATION BASED ON INTERSECTIONS AND SECTIONS

(75) Inventors: Tao Wu, Beijing (CN); Weisong Hu, Beijing (CN); Xiaowei Liu, Beijing (CN); Shaoya Wang, Beijing (CN); Chenghai Li, Beijing (CN); Weili Zhang, Beijing (CN)

(73) Assignee: NEC (China) Co., Ltd., Beijing (CN)

(21) Appl. No.: 12/942,794

(22) Filed: Nov. 9, 2010

(30) Foreign Application Priority Data
Dec. 28, 2009 (CN) 200910265616.0

(51) Int. Cl. G08G 1/00; G01C 21/36; G06K 9/00

(52) U.S. Cl. 701/117; 701/200; 382/113

(57) ABSTRACT

A method and apparatus for representing a road network and a method and system for processing traffic information data using the method for representing a road network are provided. The method for processing traffic information data comprises: conversion step of converting traffic information data based on road networks of one or more types of road maps into traffic information data of intersections and sections, based on correspondence between the road networks of one or more types of road maps and the road network represented by the intersections and the sections, wherein the road network represented by the intersections and the sections is obtained by the method for representing a road network; and fusion step of fusing the converted traffic information data of intersections and sections to obtain unified traffic information data. The present invention proposes using a road network represented by intersections and sections as an intermediate model, which emphasizes the importance of intersections as hub nodes of the road network, and is compatible with various forms of map representations and universal. In this way, more accurate and comprehensive information can be obtained by fusing traffic information data from different data sources, which is advantageous for services such as traffic information prediction.

### FIELD OF INVENTION

The present invention relates to traffic information data processing, in particular to a representation of a road network based on intersections and sections, and processing of traffic information data from various data sources by using the representation.

### DESCRIPTION OF PRIOR ART

In modern society, automobiles are becoming increasingly widespread with the rapid economic growth, which imposes more and more pressures on urban traffic and causes increasingly severe traffic jams. It is advantageous to mitigate traffic congestions, so as to reduce travel time for automobile drivers, reduce fuel consumption, improve economic efficiency of a city and facilitate environment protection. Thus, the traffic information service system plays an important role in urban intelligent traffic system.

With respect to traffic information gathering, the current rapid development of multi-media technology, mobile communication technology and the popularization of GPS technology provide great potentials for traffic information services. In traffic information gathering, stationary probing devices deployed along the roads, such as cameras, loops and RTMS (Remote Traffic Microwave Sensor), can accurately gather data for traffic information, which is, however, limited to arterial road network in general. The probe vehicle technology, which mainly uses taxies, can calculate traffic information for urban road network in real time, but it is subjected to objective constraints such as the number of probe vehicles. An information gathering personnel is capable of uploading observed traffic information as a text to a data center through a simple mobile communication device. In this case, however, information is limited in amount and also is inaccurate. A user uploading approach, in which a driver uploads traffic information for the area where he/she is currently located to a data center via a channel provided by a mobile information service provider, suffers from limited coverage. In summary, there has been a diversity of approaches for gathering traffic data. However, these approaches have different types of data formats, different description fashions and respective drawbacks in information completeness and accuracy. An effective approach for improving accuracy of traffic information and enlarging coverage is to represent traffic information data from different sources by a universal traffic information describing model, and thus to take advantages of different data sources and fuse traffic information from various data sources for supplementing each other.

As mentioned above, a universal model for modeling traffic data should comply with the geographical characteristics of traffic information in our daily life, and determine correspondence of crucial traffic information elements in different reference systems, such as in a general city map, a navigation road topology network, a traffic information report, thereby traffic data from different sources can be normalized, and subsequent fusion processing of the traffic information can be performed.

In practical, data sources of the traffic information include fixed monitor devices (such as a RTMS, a loop, a camera etc.), a mobile detection device (such as a probe vehicle network, a mobile communication subscriber network etc.) and text information (such as a road condition report from the traffic office, an information report from the information collector, instant uploads from users etc.). These data sources may be based on a simple city map or a complex road topology network of navigation digital map, or may be completely based on text description. It is desirable to provide a solution to fuse these data accurately so as to obtain more accurate traffic information with a larger coverage.

Some of the existing patent disclosures and papers have related to methods and models for modeling traffic data. These methods and models are to be improved in terms of accurate representation and fusion of the traffic data from different sources.

A method and system for modeling and processing traffic information data are proposed in Patent Document 1, US20060111833(A1) “Method and System for modeling and processing vehicle traffic data and information and applying thereof”. A concept of oriented road sections is proposed in this patent, the concept adequately considers various flow directions at a road junction and characteristics of the traffic flow, and is expected to be used for fusing traffic information data from various sources.

A traffic information fusion method for probe vehicle technology is proposed in Patent Document 2, CN200610168271.3 “Method and System for Traffic Information Fusion”, which method comprises dividing a road into plural segments based on link travel time according to a road network of a navigation map, and seeking the geographical correspondences between the sections and the links, so as to achieve the objective of computing the road condition using the travel time of links.

An apparatus and method of creating map knowledge base is proposed in Patent Document 3, CN200510125303.7 “System and method of Traffic Information Query” and Non-patent Document 1, “A Map Ontology Driven Approach to Natural Language Traffic Information Processing and Services” (published in 1st Annual Asian Semantic Web Conference, 2006), in which how to establish a knowledge object and a knowledge base for traffic information description in terms of language is proposed, and a concept of road and traffic point is proposed for supporting a natural language processing of the traffic information.

In the solutions mentioned above, Patent Document 1 has disclosed a road network established with oriented road sections, with which traffic data of different data sources are fused. The oriented road sections are sections of different directions extending from a road junction. This method enables a good traffic information fusion, but has ignored an important concept of intersection in the traffic information. Intersection is ignored completely in this fusion model, and its key node role in the road network can not be obtained or queried. Further, there are overlapping portions between road sections of different flow directions, which will cause a problem of decreased accuracy. A method directed to generating road traffic information from the travel time of links of the navigation road topology network is proposed in Patent Document 2. This method comprises dividing a road into several links and unit sections, establishing relationships between these links and the unit sections, so as to obtain the traffic information of the road. The importance of intersections in the traffic network is not considered in this method, either, and the traffic information of the road can not be obtained from this method. A method of generating a map knowledge base is proposed in Patent Document 3, the method is based on road network, and comprises extracting roads and traffic points, establishing subordination relationship between them, and using those in natural language processing. Although this method tries to describe the traffic information in a manner more conform to people's daily life language, it is limited to text form, and can not be mapped to different geographical networks or used in fusion of data from multiple sources.

As mentioned above, the conventional traffic information modeling or representing methods still have shortcomings, and fail to establish a model for traffic information modeling from the perspective of universality and practicality.

Therefore it is desirable to establish a universal and scalable model to model and process traffic information, and the model is based on positions of the road network in geographical space, and can unify data basis in different forms including city maps, navigation maps, simple maps, text-description maps etc.

### SUMMARY OF THE INVENTION

In order to address the above problems, a method and apparatus for representing a road network and a method and system for processing traffic information data using the method for representing a road network is provided. In the method for representing the road network, the road network is represented with intersections and sections being core elements and a geographical space being a reference system, and thus a model capable of reflecting the correspondence between maps with different levels of details and road description information is established.

Furthermore, by using the road network represented by intersections and sections, an ordinary city map, a navigation road topology network and traffic information data in text which are generally used in collection of the traffic information can be converted into unified traffic information data of intersections and sections for data fusing and subsequent using. As compared to the traffic information data modeling method in the prior art, the present invention emphasizes the effect of intersections as independent nodes of road network in obtaining and rendering information. Intersection is a geographical space which is expressed as a node in the road network, and intersection is also a hub of the network which tends to be congested because traffic flow in each direction influx to this single location. Therefore, road conditions of intersections are very important in the traffic information. In the method of the present invention, intersection is considered as an independent element for modeling the traffic data, different turn relationships of an intersection are extracted, and the traffic condition of the intersection is analyzed. Furthermore, a section is a road segment between adjacent intersections along a road. In this manner, the whole road topology network is composed of sections and intersections in the sense of geographical space, and traffic information is expressed with sections and intersections.

According to an aspect of the present invention, a method for representing a road network is provided comprising:

intersection extraction step of extracting parts in a road network of a road map corresponding to road intersections in a geographical space and the attributes of the parts so as to obtain the intersections and their attributes;
section extraction step of extracting parts between each of the obtained intersections and its neighboring intersection in the road network of the road map and the attributes of the parts so as to obtain the sections and their attributes;
road network representing step of representing the road network of the road map with the obtained intersections and their attributes and the sections and their attributes.

In an embodiment, the attributes of each of the intersections comprises at least the name and turn relationship of the intersection, the name of the intersection corresponds to the location and turn relationship of the respective road intersection in the geographical space, the turn relationship of the intersection describes the respective turns at the intersection, and comprises at least the geographical paths and direction description of each of the intersections. The attributes of each of the sections comprises at least geographical paths between the starting intersection and the ending intersection of the section.

The road map may comprise one or more types of maps including navigation digital map and city road map.

In an embodiment, in the intersection extraction step, for each of road names in the road map, a sequence of paths along each of traveling directions of the road of the road name is found out, and then the intersecting locations of the sequence of the paths intersecting with each of the sequences of paths belonging to the roads of another road names are found out to be parts corresponding to the road intersections in the geographical space.

According a further aspect of the present invention, a method for processing traffic information data is provided comprising:

conversion step of converting traffic information data based on road networks of one or more types of road maps into traffic information data of intersections and sections, based on correspondence between the road networks of one or more types of road maps and the road network represented by the intersections and the sections, wherein the road network represented by the intersections and the sections is obtained by the above method for representing a road network;
fusion step of fusing the converted traffic information data of intersections and sections to obtain unified traffic information data.

In an embodiment, in the fusion step, the traffic information data of each of the intersections are fused based on the turn relationship of the intersection.

In an embodiment, in the fusion step, the traffic information data of the same intersection are combined, and the traffic information data of the same section are combined.

In an embodiment, in the fusion step, the traffic information data of intersections and sections associated with each other are analyzed and combined to obtain traffic information data for an area comprising the associated intersections and sections.

The traffic information data may comprise travel speed, travel time or congestion indication, and in the fusion step, the travel speed, travel time or congestion indication is calculated for each turn at each intersection, and/or the travel speed, travel time or congestion indication is calculated for each section.

In an embodiment, the above method further comprising:

historical pattern generation step of obtaining the pattern of the traffic information data of intersections and sections by analyzing the fused traffic information data of intersections and sections, to generate historical pattern of the traffic information data; and
prediction step of predicting the traffic information at a future time based on the current traffic information data of intersections and sections and the generated historical pattern.

An apparatus for presenting road network and system for processing traffic information are also provided.

### BRIEF DESCRIPTION OF THE DRAWINGS

The above and other objects, features and advantages of the present invention will be apparent from the following detailed description taken conjunction with the drawings in which:

FIG. 1 is a schematic block diagram of an apparatus for representing a road network according to an embodiment of the present invention;

FIG. 2 is a flowchart of a method performed by the apparatus for representing the road network;

FIG. 3 is an example of part of the road network representation obtained by the apparatus for representing the road network;

FIG. 4 is a schematic diagram of different types of intersections;

FIG. 5 is a schematic block diagram of a system for processing traffic information data according to an embodiment of the present invention;

FIG. 6 is a schematic block diagram of a system for processing traffic information data according to another embodiment of the present invention; and

FIG. 7 is a flowchart of a method for processing traffic information data according to another embodiment of the present invention.

### DETAILED DESCRIPTION OF THE PREFERRED EMBODIMENTS

There are various data sources for traffic information, for example, stationary monitor devices such as a Remote Traffic Microwave Sensor, a loop or a camera etc., mobile detecting devices such as probe vehicle network or mobile communication subscriber networks, and text information such as traffic condition reports from the traffic office, information reports from information collector personnel, instantaneous upload from users. The traffic information provided by these data sources may be based on a simple city map, or may be based on a complex road topology network of navigation digital map, or may be completely based on text description. Complexities and constituents of the road networks in road maps may differ from each other, and it is generally difficult to determine associations between the traffic information pieces based on different road maps. Additionally, it is more difficult to determine associations between traffic information described in text and traffic information based on a road topology network.

For the purpose of navigation and road condition reporting, traffic information data are generally based on a geographical space, and probably may be provided with particular geographical position information of longitude and latitude, or may be approximate road information having particular features such as names, directions, etc. In addition, in people's daily life, traffic information is described generally with road and intersections, such as “The 4^{th} north ring road is congested” or “car flow from west to east at XUEYUAN Bridge is slow”. The information can be considered as atomic models of a traffic information description, in which the traffic information can be described at minimum acceptable and understandable granularity. These atomic models can be further integrated, to obtain a generalized traffic information description for a wider scope, such as “the whole 4th ring road is congested” or “XUEYUAN Bridge is congested in every direction”. Traffic information for a larger geographic scope can be obtained more quickly and accurately and a prediction of road conditions can be performed more effectively, if associations between traffic information pieces from different data sources can be determined and thus these information pieces can be fused. As an example, the traffic information from a stationary monitor device is “traveling speed on XUEYUAN Road from south to north is 10 km/h”, while what is reported by an information collection personnel located at XUEYUAN Bridge is “XUEYUAN Road is congested from west to south”. If association between the two kinds of information can be determined automatically, a conclusion that XUEYUAN Road is congested from south to north and from north to south can be obtained by fusing the two kinds of information.

Therefore it is desirable to provide a universal model for modeling and processing traffic information. The model can unify the traffic information described in different forms based on various road maps such as the city road map, the navigation map, the simple road map, and the text-description-based map.

The inventors of the present application have found that, although the descriptions of traffic information are various, all of the descriptions are substantially based on a geographical space composed of non-overlapping points and lines, wherein a point is an intersection, and a line is a road segment between adjacent intersections, referred to as a section in the specification. As such, a road is composed of a sequence of alternating points and lines, and the traffic information can be described with intersections and sections from the perspective of a road. The constituent elements composing a road topology network in one road map are different from those in another road map, for example, the road network of a navigation digital map is composed of links and nodes with longitude and latitude information, a general city map is composed of paths and crossings with particular names, and a text description-based map is composed of descriptions of road names and directions. However, every constituent element has certain correspondence with the geographical space composed of intersections and sections described above. For example, a link or path representative of part of some road generally has the name of the road, and a node or crossing also has the name of a corresponding intersection in geographical space. Therefore, it may be considered to use the geographical space composed of intersections and sections as an intermediate model for fusing traffic information data from different sources. For example, when traffic information data are received from different sources, these traffic information data based on different constituent elements can be first converted into traffic information based on intersections and sections, according to correspondence between the constituent elements and intersections and sections. Then, the information can be fused so as to provide more comprehensive and accurate traffic information for reporting and predicting road conditions.

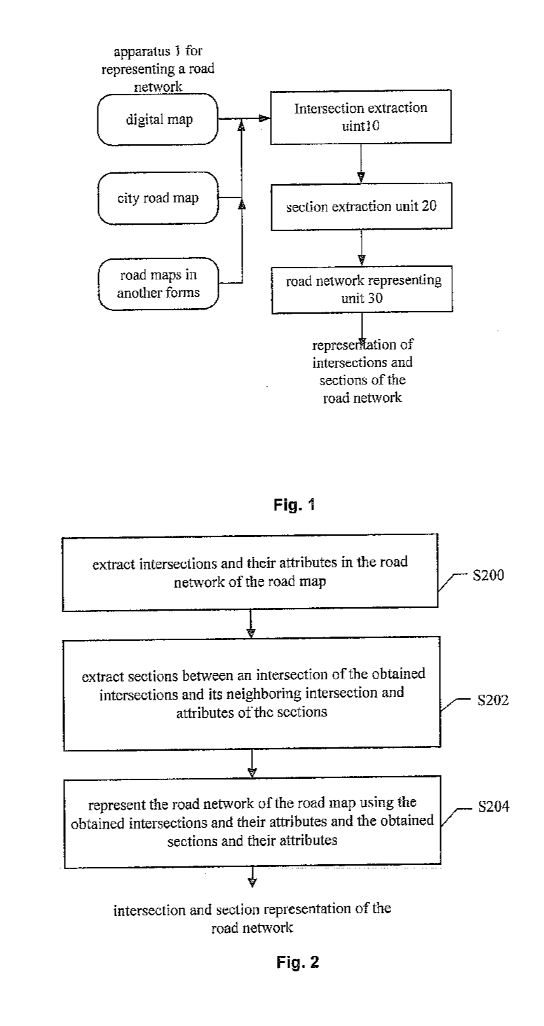

Based on the inventive concept described above, a method and apparatus for representing a road network is provided, in which intersections and sections are used to represent the road network to establish an intermediate model compatible with various road maps. A process of representing the road network according to an embodiment of the present invention is described below with reference to FIG. 1.

An apparatus 1 for representing the road network according to the embodiment of the present invention is illustrated in FIG. 1, comprising: intersection extraction unit 10 for extracting parts in a road network of a road map corresponding to road intersections in a geographical space and the attributes of the parts so as to obtain the intersections and their attributes; section extraction unit 20 for extracting parts between each of the obtained intersections and its neighboring intersection in the road network of the road map and the attributes of the parts so as to obtain the sections and their attributes; and road network representing unit 30 for representing the road network of the road map with the obtained intersections and their attributes and the sections and their attributes.

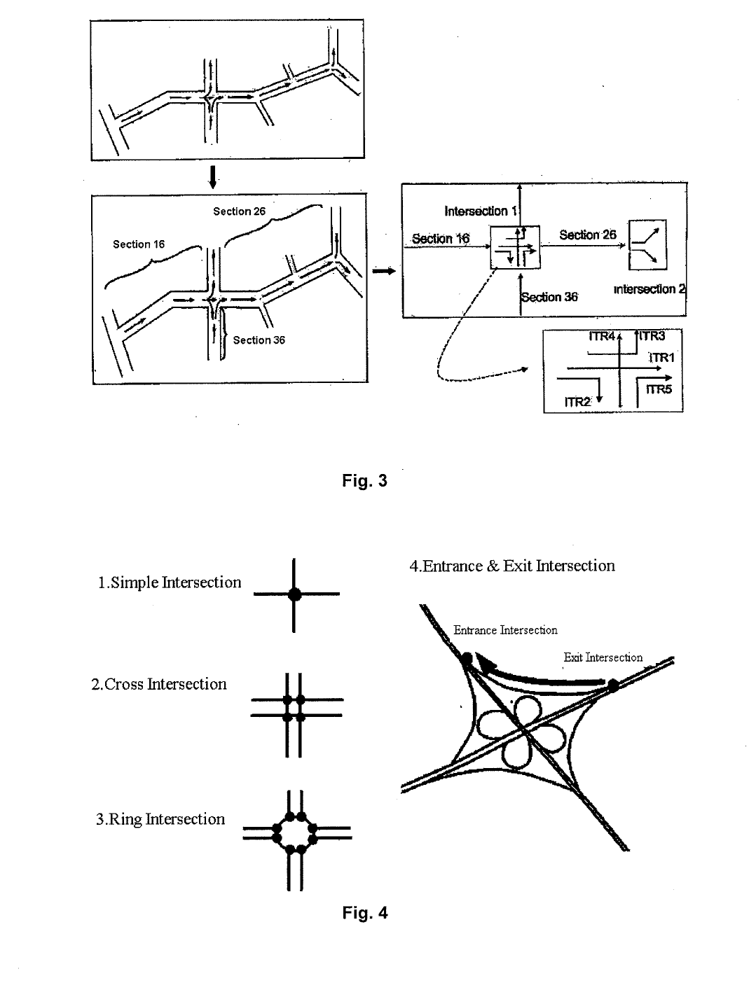

As mentioned above, constituent elements composing one road network are different from those composing another road network, such as the road topology network of the navigation digital map is composed of links and nodes, comprising topology of roads, wherein some of the links contain information of road names. In general, a bidirectional road is represented by two unidirectional path lines. A city map is represented generally by simplified road path in a road network of city map, and a road is represented generally by a center line of a real path and has a road name and intersection names. A road map in text has names of roads and intersections. To establish correspondence between these maps, a geographical space corresponding to each road name may be found out. In this embodiment, intersection extraction unit 10 extracts names of respective roads from the road map, and for each road name, finds out a sequence of paths along each of traveling directions of the road having the road name. Here, the term “Path” is a generic term of constituent elements for roads in various road maps. For example, path may be a link in a navigation digital map or may be a road segment in a city map. In an embodiment, the sequence of paths may be a complete geographical path, and the path in each of the directions is continues, as shown by arrows in FIG. 3. In an embodiment, the bidirectional road in the geographical space can be represented as two unidirectional roads which may have the same names as the name of the bidirectional road. Subsequently, for each road, intersection extraction unit 10 finds out intersection locations of the sequence of the paths intersecting with each of the sequences of paths belonging to the roads of another road names, and the intersection locations correspond to road intersections in the geographical space, i.e., intersections at which the road is intersected with other roads. An intersection can be named based on the location and turn relationship of the intersection in the geographical space. For example, an intersection can be named as “intersection from XX road to XX road”. If an intersection has its own name, the name of the intersection can also be obtained directly from the road map, or be set manually as a name used in people's daily life, so as to be compatible with a text description-based map used in people's daily life. Thereby, intersection extraction unit 10 can obtain all of the intersections and their names by performing the operations described above for each road name.

An intersection is a geographical space where traffic flows in various directions converge. In the present invention, as an independent element used for describing traffic information, the intersection is subdivided, i.e., the intersection's turn relationship in different directions is extracted for further analyzing the traffic condition. As an example, a generalized description “XX intersection is congested/the speed on XX intersection is 10 km/h” is not sufficient for analyzing and predicting the traffic condition. If more details can be obtained such as “the speed on XX intersection from east to south is 10 km/h”, “the speed on XX intersection from west to north is 40 km/h”, it can be explicitly known that congestion may occur at the east-to-south turn of an intersection, while the road from the west-to-north turn is unblocked. Therefore, drivers of vehicles can determine a non- or less-congested route from this intersection, instead of purely knowing that the intersection is congested. Therefore, in addition to the name attribute, the attribute of the intersection includes at least turn relationship, which is a description of respective turns of the intersection and which includes a description of the geographical path and direction of each turn. In general, a common cross intersection may have 12 turn directions (in this embodiment a straightforward proceeding direction of the intersection is also included in the turn relationship), including from north to south, from south to north, from east to west, from west to east, from north to east, from east to north, from north to west, from west to north, from south to east, from east to south, from south to west, and from west to south. In order to clearly describe the turn relationship of the intersection, in the embodiment of the present invention the turn relationship of the intersection may be described with a description of the passed geographical path (generally including entry path and exit path) and direction. For example, for “an intersection from 4th north ring road to XUEYUAN road”, this intersection's turn relationship may include “passed geographical path: entry—4th north ring road, exit—XUEYUAN road, turn: from east to north”, “entry—XUEYUAN road, exit—4th north ring road, turn: from south to east”. As an example, the turn relationship of the intersection may also include a description of turn angle and the like.

Further, those skilled in the art will appreciate that, in addition to name and turn relationship, the attributes of an intersection may include other attributes, such as type of the intersection. The intersection may be of various types, for example cross intersection, T-shaped intersection, ring intersection, trunk road exit, trunk road entrance, road terminal. The various types of intersections are illustrated in FIG. 4. For different types of intersections, the attributes of the intersections may be represented in any other appropriate form. For example, for the trunk road exit/entrance, the trunk road path and side road path may be indicated explicitly.

Alternatively, the road network representing apparatus 1 may further comprise a intersection storing unit (not shown) for storing the obtained intersections and their attributes after the intersections and their attributes are extracted by the intersection extraction unit 10.

After the intersections on the respective roads are obtained by the intersection extraction unit 10, the section extraction unit 20 extracts, as sections, respective parts between adjacent intersections in the road network of the road map. Furthermore, the section extraction unit 20 obtains attributes of each of the sections comprising at least geographical paths between the starting and ending intersection of the section. In addition, those skilled in the art will appreciate that the attributes of the section may comprise other attributes, such as directions of the section and the name of the road including the section.

Alternatively, the road network representing apparatus 1 may further comprise a section storing unit (not shown) for storing the obtained sections and their attributes after the sections and their attributes are extracted by the section extraction unit 20.

Then, the road network representing unit 30 represents the road network of the road map by using the obtained attributes of the intersections and sections. With reference to FIG. 3, an example of the representation of parts of the road network obtained by the road network representing apparatus 1 is illustrated. The upper left portion of FIG. 3 represents the original traffic flow direction, and what is within the brackets at the lower left portion of FIG. 3 represents sections. The right portion of FIG. 3 shows relationships between intersections and sections. Section 16, Section 26, and Section 36 are sections between intersections; Intersection 1 is an intersection; and ITR 1, ITR 2, ITR 3, ITR 4, and ITR 5 are turn relationships of Intersection 1.

Alternatively, road network representing apparatus 1 may further comprise a intersection and section representation storing unit (not shown) for storing the intersection and section representation of the road network of the road map after the intersection and section representation of the road map is obtained by the road network representing unit 30.

FIG. 2 illustrates a flowchart performed by the road network representing apparatus. At step 200, intersection extraction unit 10 extracts intersections and their attributes including road names and turn relationships from the road network of the road map. At step 202, section extraction unit 20 extracts sections between each of the obtained intersections and its neighboring intersection in the road network of the road map and the attributes of the sections. At step 204, road network representing unit 30 represents the road network of the road map with the obtained intersections and their attributes and the sections and their attributes.

As mentioned above, almost every description of traffic information is substantially based on a geographical space composed of non-overlapping points and lines, wherein the point is an intersection, and the line is a section between adjacent intersections. So, a road is composed of a sequence of alternating intersections and sections, and thus the traffic information can be described by intersections and sections from the perspective of a road. Thus, the road network represented by intersections and sections may be used as an intermediate model compatible with various road maps for converting and unifying traffic information based on various road maps. In addition, in the road network representation of intersections and sections, the description of attributes of the intersections and sections has already included a map based on text description. As a result, the road network representation of the intersections and sections is also suitable for traffic information described in text and traffic information uploaded by users or collected manually.

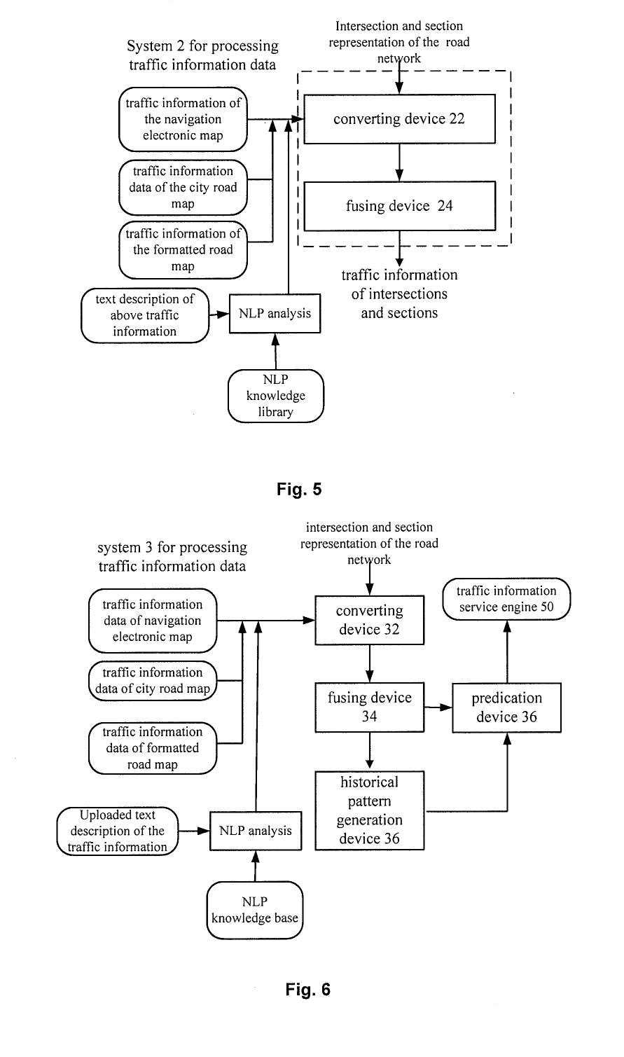

Next refer to FIG. 5, a system 2 for processing traffic information data according to an embodiment of the present invention is described to convert and fuse various forms of traffic information data from different data sources and/or based on different road maps, by using a road network represented by intersections and sections.

The system 2 for processing traffic information data comprises: conversion device 22 for converting traffic information data based on one or more types of road maps into traffic information data of intersections and sections, based on correspondence between the road networks of one or more types of road maps and the road network represented by the intersections and the sections, wherein the road network represented by the intersections and the sections may be pre-obtained by the apparatus 1 for representing a road network and stored in the intersection and section representation storing unit; and fusion device 24 for fusing the converted traffic information data of intersections and sections to obtain unified traffic information data. Alternatively, the system 2 for processing traffic information data may also comprise the apparatus 1 for representing the road network.

With reference to FIG. 3, an input to the system 2 for processing traffic information data may comprise various forms of traffic information data from various data sources, for example, including traffic information data of a road network of a navigation digital map, which is derived from a fixed traffic monitoring device and probe vehicles, traffic information data of a road network of a simplified city map, formatted traffic information data represented in some fixed format, for example information from the traffic management office, and text uploaded by user, which is represented in daily-life language, used in an traffic information service and communication platform, and expressed in natural language.

All of the above three types of traffic information are based on certain forms of road networks and generally have fixed formats. For example, the traffic information data based on a navigation digital map generally includes road traveling time and traveling speed etc., based on links, and formatted traffic information data is generally based on a traffic condition description of road-intersection-section. Therefore, the information could be input directly into the system 2 for processing traffic information data for further processing. Text uploaded by users, due to its natural language expression, should be subjected to natural language process (NLP) analysis before being input to the system 2. The natural language process analysis may be performed by any known NLP method in the prior art with reference to a NLP knowledge base, to extract names of relevant intersections and roads and traffic conditions of the intersections and roads. The analysis can be performed by means of any known method and apparatus, details of which are thus omitted here.

The converting device 22 receives the various forms of input traffic information data as described above, and converts the traffic information data with reference to a road network represented by intersections and sections. For example, the converting device 22 may associate the traffic information data to respective intersections and sections in accordance with names, directions, paths and the like in the traffic information, to obtain traffic information data based on intersections and sections. The converted traffic information data based on intersections and sections can be stored in a storage unit or directly provided to fusing device 24.

The fusing device 24 fuses the converted intersections and sections traffic information data to obtain a unified traffic information data. The traffic information data may include traveling speed, traveling time and congestion indication. Thereby, the fusing device 24 may compute the traveling speed, traveling time and congestion indication for respective turns of an intersection and/or compute the traveling speed, traveling time or degree of congestion on a section. For an intersection, the fusing device 24 may fusing the traffic information data of the intersection in accordance with the turn relationships of the intersection, so that the traffic information data of the intersection is subdivided in each direction, and the traffic condition of the intersection may be reflected more specifically and clearly than a general description such as “XX intersection is congested”.

Since there are various forms of traffic information data, in the converted intersections and sections traffic information data, a single intersection and/or section might have more than one piece of associated traffic information data. The fusing device 24 may fuse traffic information data for a single intersection and/or section, and thus obtain more accurate and reliable traffic information. For example, for a single section, the traveling time on this section provided in plural pieces of traffic information data may be averaged, and the average value may be used as traffic information data for this section. Alternatively, traffic information data from different sources may be allocated with different weights in accordance with the reliability and real-time of these traffic information data sources. For example, since the reliability and real-time of the traffic information data collected manually are generally higher than those of the traffic information data provided by the traffic monitor device, a larger weight may be assigned to the former, and a smaller weight may be assigned to the latter, so that a weighted average can be obtained. Those skilled in the art will appreciate that information data of a single object can also be fused by various known methods.

Further, traffic information data from different data sources may have provided traffic information data of different intersections and/or sections, so that in the converted traffic information data, there may be traffic information data belonging to an intersection/section as well as traffic information belonging to other sections/intersections associated with the intersection/sections/. The fusing device 24 may fuse the traffic information data of the intersections/sections and their associated intersections/sections, so as to obtain more comprehensive traffic information for a larger coverage. For example, traffic information from a fixed monitor device is “traveling speed on XUEYUAN road from south to north is 10 km/h”, while a collector personnel located at XUEYUAN Bridge (the intersection at which the 4th north ring road is intersected with the XUEYUAN road) reports that “XUEYUAN Bridge is congested along the direction from west to south”. If association between these two pieces of information could be determined automatically, it can be obtained that XUEYUAN road is congested from south to north and from north to south, by fusing these two pieces of information.

Furthermore, fusing device 24 may fuse traffic information data of intersections and sections belonging to a single road, and may obtain the traffic condition of the entire road.

Those skilled in the art will appreciate that the fusing device 24 may further fuse traffic information of intersections and sections in other manners according to applications and requirements. The present invention is not limited to the above fusing scheme.

The fused traffic information data of intersections and sections may be stored in the storage unit or database for further traffic information analyzing, prediction and road condition query etc. FIG. 6 illustrates a schematic block diagram of a system 3 for processing traffic information data according to another embodiment of the present invention, in which history mode analyzing and predicting of road condition is performed using the fused traffic information data of intersections and sections so as to be provided to a traffic information service platform.

Compared to the above system 2 for processing traffic information data, the converting device 32 and the fusing device 34 of the processing system 3 are identical to the above converting device 22 and fusing device 24 in terms of functionality, respectively, and thus details of them are omitted here. The processing system 3 further comprises: historical pattern generation device 36 for obtaining the pattern of the traffic information data of intersections and sections by analyzing the fused traffic information data of intersections and sections, to generate historical pattern of the traffic information data; and prediction device 34 for predicting the traffic information at a future time based on the current traffic information data of intersections and sections from the fusing device 34 and the generated historical pattern.

The traffic information data of intersections and sections fused by the fusing device 34 is provided to the historical pattern generation device 36, which in turn accumulates the traffic information as historical information, and obtains traffic information data pattern, such as a curve of average traveling time or speed over respective time periods, for sections and respective turns of intersections, according to the historical information. Such traffic information data pattern can be used as historical pattern for use in predicting and a defaulted situation. Prediction device 38 predicts traffic information at a future time according to the current traffic information data of intersections and sections from the fusing device 34 and the historical pattern generated by the historical pattern generation device 36. Operations of historical pattern generation device 36 and prediction device 38 may be performed via any suitable conventional technology, such as the pattern generating and predicting technologies recited in Patent Document 1, and thus details of them are omitted here.

Traffic information of intersections and sections obtained by the prediction device 38 may be stored in a storage unit and provided to, for example, the traffic information service engine/platform 50 for relevant services, such as a service for providing prediction of road conditions and driving navigation service, by using the predicted traffic information.

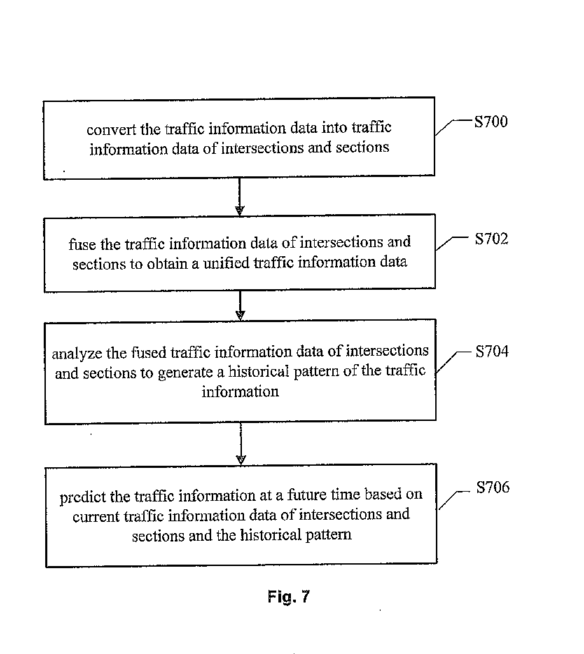

FIG. 7 illustrates a flowchart of the method for processing traffic information data according to an embodiment of the present invention. At step 700, converting device 32 receives traffic information data from different data sources, and converts the traffic information data into traffic information of intersections and sections respectively with reference the road network represented by intersections and sections. At step 702, fusing device 34 fuses the converted traffic information of intersections and sections so as to obtain a unified traffic information data. At step 704, historical pattern generation device obtains the pattern of the traffic information data of intersections and sections by analyzing the fused traffic information data of intersections and sections, to generate historical pattern of the traffic information data. At step 706, prediction device predicts the traffic information at a future time based on the current traffic information data of intersections and sections and the generated historical pattern.

A method and apparatus for processing traffic information data according to specific embodiments of the present invention are described above, wherein a geographical space composed of intersections and sections is used as a intermediate model for fusing traffic information data from different sources. When traffic information data from different sources are received, traffic information data based on different constituent elements is first converted into traffic information data of intersections and sections, and then the converted traffic information data are fused, so as to provide a more comprehensive and accurate traffic information for reporting and predicting of road conditions.

It should be noted that the foregoing illustrates the solutions of the present invention by way of example only and is not intended to limit the present invention to the steps and element structures as described above. It is possible to adjust and modify such steps and element structures as desired. Thus, some of the steps and elements are not essential for implementing the general concept of the present invention. Accordingly, the essential technical features of the present invention are limited by only the minimum requirements for implementing the general concept of the present invention, rather than the above particular embodiments.

The present invention has the following advantages. A road network represented by intersections and sections is proposed as an intermediate model and correspondences between different levels of maps and intersections and sections are established, taking into account traffic information characteristics in a description in people's daily life language. The importance of an intersection as a hub node of a road network is emphasized, and different turn paths of an intersection are finely extract, and thus the traffic information can be processed more accurately. By fully considering the characteristics of traffic flows, traffic information on a single section is substantially consistent, while the traffic information for turns of an intersection may differ from each other. Such ideas make processing of traffic information data more accurate, compatible with various forms of map representations and thus universally applicable.

To this end, the present invention has been disclosed with reference to the preferred embodiments thereof. It can be appreciated that any other modifications, alternatives and additions can be made by those who skilled in the art without departing from the spirits and scope of the present invention. Therefore, the scope of the present invention is not limited to the above particular embodiments, but only limited by the claims as attached.

1. A method for representing a road network, comprising:
intersection extraction step of extracting parts in a road network of a road map corresponding to road intersections in a geographical space and the attributes of the parts so as to obtain the intersections and their attributes;
section extraction step of extracting parts between each of the obtained intersections and its neighboring intersection in the road network of the road map and the attributes of the parts so as to obtain the sections and their attributes;
road network representing step of representing the road network of the road map with the obtained intersections and their attributes and the sections and their attributes.

2. The method of claim 1, wherein the attributes of each of the intersections comprises at least the name and turn relationship of the intersection,
the name of the intersection corresponds to the location and turn relationship of the respective road intersection in the geographical space,
the turn relationship of the intersection describes the respective turns at the intersection, and comprises at least the geographical paths and direction description of each of the intersections.

3. The method of claim 1, wherein the attributes of each of the sections comprises at least geographical paths between the starting intersection and the ending intersection of the section.

4. The method of claim 1, wherein the road map comprises one or more types of maps including navigation digital map and city road map.

5. The method of claim 1, wherein in the intersection extraction step, for each of road names in the road map, a sequence of paths along each of traveling directions of the road of the road name is found out, and then the intersecting locations of the sequence of the paths intersecting with each of the sequences of paths belonging to the roads of another road names are found out to be parts corresponding to the road intersections in the geographical space.

6. A method for processing traffic information data, comprising:
conversion step of converting traffic information data based on road networks of one or more types of road maps into traffic information data of intersections and sections, based on correspondence between the road networks of one or more types of road maps and the road network represented by the intersections and the sections, wherein the road network represented by the intersections and the sections is obtained by the method for representing a road network of claim 1;
fusion step of fusing the converted traffic information data of intersections and sections to obtain unified traffic information data.

7. The method of claim 6, wherein in the fusion step, the traffic information data of each of the intersections are fused based on the turn relationship of the intersection.

8. The method of claim 6, wherein in the fusion step, the traffic information data of the same intersection are combined, and the traffic information data of the same section are combined.

9. The method of claim 6, wherein in the fusion step, the traffic information data of intersections and sections associated with each other are analyzed and combined to obtain traffic information data for an area comprising the associated intersections and sections.

10. The method of claim 6, wherein the traffic information data comprise travel speed, travel time or congestion indication,
in the fusion step, the travel speed, travel time or congestion indication is calculated for each turn at each intersection, and/or the travel speed, travel time or congestion indication is calculated for each section.

11. The method of claim 6, further comprising:
historical pattern generation step of obtaining the pattern of the traffic information data of intersections and sections by analyzing the fused traffic information data of intersections and sections, to generate historical pattern of the traffic information data; and
prediction step of predicting the traffic information at a future time based on the current traffic information data of intersections and sections and the generated historical pattern.

12. An apparatus for representing a road network, comprising:
intersection extraction unit for extracting parts in a road network of a road map corresponding to road intersections in a geographical space and the attributes of the parts so as to obtain the intersections and their attributes;
section extraction unit for extracting parts between each of the obtained intersections and its neighboring intersection in the road network of the road map and the attributes of the parts so as to obtain the sections and their attributes;
road network representing unit for representing the road network of the road map with the obtained intersections and their attributes and the sections and their attributes.

13. The apparatus of claim 12, wherein the intersection extraction unit, for each of road names in the road map, finds out a sequence of paths along each of traveling directions of the road of the road name, and then finds out the intersecting
locations of the sequence of the paths intersecting with each of the sequences of paths belonging to the roads of another road names to be parts corresponding to the road intersections in the geographical space.

14. A system for processing traffic information data, comprising:
conversion device for converting traffic information data based on road networks of one or more types of road maps into traffic information data of intersections and sections, based on correspondence between the road networks of one or more types of road maps and the road network represented by the intersections and the sections, wherein the road network represented by the intersections and the sections is obtained by the apparatus for representing a road network of the claim 12;
fusion device of fusing the converted traffic information data of intersections and sections to obtain unified traffic information data.

15. The system of claim 14, wherein the fusion device fuses the traffic information data of each of the intersections based on the turn relationship of the intersection.

16. The system of claim 14, wherein the fusion device combines the traffic information data of the same intersection, and combines the traffic information data of the same section.

17. The system of claim 14, wherein the fusion device analyzes and combines the traffic information data of intersections and sections associated with each other to obtain traffic information data for an area comprising the associated intersections and sections.

18. The system of claim 14, wherein the traffic information data comprise travel speed, travel time or congestion indication,
the fusion device calculates the travel speed, travel time or congestion indication for each turn at each intersection, and/or the travel speed, travel time or congestion indication for each section.

19. The system of claim 14, further comprising:
historical pattern generation device for obtaining the pattern of the traffic information data of intersections and sections by analyzing the fused traffic information data of intersections and sections, to generate historical pattern of the traffic information data; and
prediction device for predicting the traffic information at a future time based on the current traffic information data of intersections and sections and the generated historical pattern.
